(19) United States
(12) Patent Application Publication
(10) Pub. No.: US 2007/0072012 A1
(43) Pub. Date: Mar. 29, 2007

(54) Magnetic recording medium using grain isolation type film as under layer, method of manufacturing the same, and magnetic recording/reproducing apparatus using the same

(76) Inventors: Futoshi Nakamura, Ichikawa-shi (JP); Soichi Oikawa, Hachioji-shi (JP); Takeshi Iwasaki, Yokohama-shi (JP); Tomoyuki Maeda, Kawasaki-shi (JP); Kenji Shimizu, Chiba-shi (JP); Hiroshi Sakai, Ichihara-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/564,316

(22) PCT Filed: Jul. 13, 2004
(86) PCT No.: PCT/JP04/10271

§ 371 Date: Jun. 21, 2006

Related U.S. Application Data
(60) Provisional application No. 60/489,487, filed on Jul. 24, 2003.

(30) Foreign Application Priority Data
Jul. 14, 2003 (JP) 2003-196559

(51) Int. Cl. G11B 5/66

(52) U.S. Cl. 428/831.2

(57) ABSTRACT

To provide a magnetic recording medium having a magnetic recording layer consisting of fine crystal grains with improved orientation. The soft magnetic layer 3, the seed layer 4, the under layer 5 and the magnetic recording layer 7 are formed successively on the non-magnetic substrate 1, wherein the seed layer 4 is made of a material containing Ni, the under layer 5 has a grain isolation type structure in which grains made of a non-magnetic material are isolated in a non-magnetic matrix and the non-magnetic matrix is made of a material containing Y₂O₃. With this constitution, the under layer 5 has improved characteristics in terms of uniformity of grains, sharpness of grain boundary, fineness of the grains and crystal orientation, and therefore the magnetic recording layer 7 that is formed on the under layer also has improved characteristics in terms of uniformity of grains, sharpness of grain boundary, fineness of the grains and crystal orientation. As a result, medium noise and coercive force are improved, thus making high density recording possible.

### BACKGROUND OF THE INVENTION

1. Field of the Invention

The present invention relates to a magnetic recording medium used in hard disk apparatuses and the like that employ magnetic recording technology, a method of manufacturing the same, and a magnetic recording/reproducing apparatus using the same.

Priority is claimed on Japanese Patent Application No. 2003-196559, filed Jul. 14, 2003, the content of which is incorporated herein by reference. This application is an application filed under 35 U.S.C. 111(a) claiming pursuant to 35 U.S.C. 119(e) of the filing date of Provisional Application 60/489,487 on Jul. 24, 2003, pursuant to 35 U.S.C. 111(b).

2. Description of Related Art

In order to increase the recording density of a magnetic recording medium, it is important to form fine grains of crystal and reduce medium noise without disturbing the anisotropy of a magnetic recording layer.

Various under layers and seed layers have been used in the past to form fine grains of crystal in the magnetic recording layer. For example, there has been used a magnetic recording medium comprising a seed layer made of Ti or Ta, an under layer having a structure in which crystal grains of hexagonal close-packed structure (hcp) or face-centered cubic structure (fcc) are separated by an oxide or a nitride is formed on the seed layer and an intermediate layer and magnetic recording layer are stacked thereon.

In this magnetic recording medium, the crystal grains that constitute the magnetic recording layer are made fine and are separated from each other (refer to, for example, Patent Document 1).

There has also be proposed a constitution in which a non-magnetic intermediate layer having structure of separating crystal grains by an oxide or a carbide is provided and magnetic layer is formed thereon, thereby to improve the coercive force and reduce noise (refer to, for example, Patent Document 2).

According to the prior art described above, by providing the under layer (or intermediate layer) having a structure in which the crystal grains are made finer and separated by using an oxide or the like, the crystal grains included in the magnetic recording layer are also made finer and separated from each other, thereby improving the recording and reproduction characteristics over conventional devices that employ under layers without such a structure.

It has also been proposed to provide a seed layer below the under layer so as to improve the orientation of the under layer, thereby to improve the orientation of the magnetic layer, too, and improve the recording and reproduction characteristics of the medium.

However, there has been such a problem in the prior art in that it is difficult to satisfy both requirements of finer crystal grains in the under layer and higher orientation.

It has also been proposed to provide a soft magnetic layer made of a soft magnetic material between the substrate and the magnetic recording layer, so as to improve the efficiency of switching the magnetic flux between a state of infiltrating the gap between the magnetic head and the magnetic recording medium and another state. The soft magnetic layer constitutes a part of the magnetic path between the magnetic head and the medium.

In the case in which the seed layer is provided, there has been a problem in that the distance between the soft magnetic layer and the head increases, and therefore it becomes difficult to achieve satisfactory recording resolution.

It has also been proposed to use an under layer having granular structure made of one kind selected from among oxide, nitride, carbide and carbon and Ru alloy, or an under layer made of Ru alloy, so as to improve the orientation and coercive force of the magnetic layer, and make the grains finer thereby to reduce the noise (refer to, for example, Patent Document 3).

However, in the magnetic recording medium provided with the under layer containing the Ru alloy, the under layer has insufficient orientation and satisfactory performance has not been achieved with respect to the coercive force and noise.

Patent Document 1

Japanese Patent Application, First Publication No. 2003-36525

Patent Document 2

Japanese Patent Application, First Publication No. 2002-133645

Patent Document 3

Japanese Patent Application, First Publication No. 2001-291230

### SUMMARY OF THE INVENTION

The present invention has been made in consideration of the background described above, and a first object thereof is to provide a magnetic recording medium comprising a magnetic recording layer of which crystal grains are made fine and crystal orientation is improved, a method of manufacturing the same, and a magnetic recording/reproducing apparatus that uses the same.

A second object of the present invention is to provide a magnetic recording medium in which crystal grains are made fine, the orientation is improved and the recording resolution is improved, a method of manufacturing the same, and a magnetic recording/reproducing apparatus using the same.

(1) The first aspect for achieving the objects described above is a magnetic recording medium comprising a soft magnetic layer, a seed layer, an under layer and a magnetic recording layer stacked successively on a non-magnetic substrate, wherein the seed layer is made of a material containing Ni, and the under layer has a grain isolation type structure where grains made of a non-magnetic material are isolated in a non-magnetic matrix and the non-magnetic matrix is made of a material containing Y₂O₃.

(2) The second aspect for achieving the objects described above is a magnetic recording medium described in (1), wherein the grains are made of a non-magnetic material containing at least one element selected from among Pt, Pd, Ru and Rh.

(3) The third aspect for achieving the objects described above is a magnetic recording medium comprising a soft magnetic layer, a seed layer, an under layer and a magnetic recording layer stacked successively on a non-magnetic substrate, wherein the seed layer is made of a material containing Ni, the under layer has a grain isolation type structure where grains made of a non-magnetic material are isolated in a non-magnetic matrix while the non-magnetic matrix is made of a material containing at least one kind selected from among metal oxide, metal nitride, metal carbide, oxide of semiconductor, nitride of semiconductor and carbide of semiconductor, and the grains are made of a non-magnetic material containing at least one element selected from among Au, Ag and Cu.

(4) The fourth aspect for achieving the objects described above is a magnetic recording medium described in (3), wherein the non-magnetic matrix is made of a material containing at least one selected from among SiO₂, Y₂O₃, Cr₂O₃, Al₂O₃ and Ta₂O₅.

(5) The fifth aspect for achieving the objects described above is a magnetic recording medium described in any one of (1) to (4), wherein a second under layer made of a material containing Ru is provided between the under layer and the magnetic recording layer.

(6) The sixth aspect for achieving the objects described above is a magnetic recording medium described in any one of (1) to (5), wherein the seed layer contains at least one element selected from among Fe, Co, Cr, V, Mo, Nb, Zr, W, Ta, B and C.

(7) The seventh aspect for achieving the objects described above is a magnetic recording medium described in any one of (1) to (6), wherein the seed layer has magnetic flux density for saturation Bs of 0.2 T or higher, and coercive force Hc of 100 Oe or less.

(8) The eighth aspect for achieving the objects described above is a magnetic recording medium described in any one of (1) to (7), wherein the magnetic recording layer is made of a Co alloy containing a metal oxide or an oxide of a semiconductor.

(9) The ninth aspect for achieving the objects described above is a method of manufacturing a magnetic recording medium comprising a soft magnetic layer, a seed layer, an under layer and a magnetic recording layer stacked successively on a non-magnetic substrate, in which the seed layer is made of a material containing Ni and the under layer has a grain isolation type structure in which grains made of a non-magnetic material are isolated in a non-magnetic matrix and the non-magnetic matrix is made of a material containing Y₂O₃.

(10) The tenth aspect for achieving the objects described above is a method of manufacturing a magnetic recording medium, which comprises forming a soft magnetic layer, a seed layer, an under layer and a magnetic recording layer successively on a non-magnetic substrate, wherein the seed layer is made of a material containing Ni, while the under layer has a grain isolation type structure in which grains made of a non-magnetic material are isolated in a non-magnetic matrix and the non-magnetic matrix is made of a material containing at least one kind selected from among metal oxide, metal nitride, metal carbide, oxide of semiconductor, nitride of semiconductor and carbide of semiconductor, and the grains are made of a material containing at least one element selected from among Au, Ag and Cu.

(11) The eleventh aspect for achieving the objects described above is a magnetic recording/reproducing apparatus comprising the magnetic recording medium of any one of (1) to (8), and a magnetic head.

In the specification of the present application, it is assumed that 1 Oe≈79.58 A/m, and 1 emu/cm³≈12.57×10⁻⁴ Wb/m².

With the magnetic recording medium of the present invention, since the seed layer made of a material containing Ni and the under layer having a grain isolation type structure are provided, uniformity of grains, sharpness of grain boundary, fineness of the grains and crystal orientation of the under layer are improved.

Thus, the magnetic recording layer that is formed on the under layer also has improved characteristics in terms of uniformity of grains, sharpness of grain boundary, fineness of the grains and crystal orientation.

As a result, medium noise can be reduced and noise characteristic can be improved. Also, coercive force can be increased and satisfactory recording and reproduction characteristics can be achieved, thus making high density recording possible.

The present invention also improves the recording resolution by using a soft magnetic material for the seed layer.

### BRIEF DESCRIPTION OF THE DRAWINGS

FIG. 1 is a schematic sectional view showing an example of the magnetic recording medium according to the invention.

FIG. 2 is a schematic sectional view showing another example of the magnetic recording medium according to the invention.

FIG. 3 is a schematic sectional view showing the magnetic recording medium of Comparative Example.

FIG. 4 is a schematic sectional view showing the magnetic recording medium of Comparative Example.

FIG. 5 is a schematic sectional view showing another example of the magnetic recording medium according to the invention.

FIG. 6 is a schematic sectional view showing another example of the magnetic recording medium according to the invention.

FIG. 7 is a partially exploded perspective view showing an example of the magnetic recording/reproducing apparatus according to the invention.

FIG. 8 is a photograph showing the planar structure of the under layer.

### DETAILED DESCRIPTION OF THE INVENTION

The magnetic recording medium of the present invention comprises a soft magnetic layer, a seed layer, an under layer and a magnetic recording layer stacked successively on a non-magnetic substrate.

The non-magnetic substrate may be a metal substrate made of aluminum, aluminum alloy or other metallic material, or a non-metallic substrate made of glass, ceramic, silicon, silicon carbide, carbon or other non-metallic material.

As a glass substrate, amorphous glass or crystallized glass may be used, while applicable amorphous glass contains general-purpose soda lime glass and aluminosilicate glass, and as the crystallized glass, lithium-based crystallized glass may be used. As a ceramic substrate, sintered material based on aluminum oxide, aluminum nitride or silicon nitride as the main component, or one of these materials reinforced with fibers may be used.

The soft magnetic layer is made of a soft magnetic material, of which those having high magnetic flux density for saturation and good soft magnetic characteristic are preferably used, such as CoZrNb alloy, FeCoB alloy, FeCoN alloy, FeTaC alloy, FeTaN alloy, FeNi alloy and FeAlSi alloy.

Coercive force Hc of the soft magnetic layer is preferably 50 Oe or less, more preferably 10 Oe or less. Magnetic flux density for saturation Bs of the soft magnetic layer is preferably 0.6 T or higher, more preferably 1 T or higher. Product of the magnetic flux density for saturation Bs and the thickness t of the soft magnetic layer, Bs·t, is preferably 40 T·nm or greater, more preferably 60 T·nm or greater.

A bias applying layer may be provided between the substrate and the soft magnetic layer.

The bias applying layer may be formed as a magnetic domain control layer that suppresses magnetic domains from being formed in the soft magnetic layer. The magnetic domain control layer is made of a hard magnetic material and has magnetic anisotropy in directions parallel to the surface. The bias applying layer may be an antiferromagnetic layer made of an antiferromagnetic material.

The material used to form the bias applying layer may be CoCrPt alloy, CoCrPtB alloy, CoCrPtTa alloy, CoSm alloy, CoPt alloy, CoPtO alloy, CoPtCrO alloy, CoPt—SiO₂ alloy, CoCrPt—SiO₂ alloy or CoCrPtO—SiO₂ alloy.

The bias applying layer may be formed in 2-layer structure, such that a second layer consisting of Co alloy is formed on a first layer consisting of V.

Forming the bias applying layer makes it possible to prevent magnetic domain walls from being formed from the soft magnetic material by means of the bias magnetic field emanating from the bias applying layer, thereby preventing spike noise from being generated due to magnetic domains.

The seed layer is for improving the crystal orientation of the under layer, and is made of a material containing Ni.

The seed layer may be formed from a Ni alloy containing at least one element selected from among Fe, Co, Cr, V, Mo, Nb, Zr, W, Ta, B and C.

For the Ni alloy, NiTa alloy, NiNb alloy, NiTaC alloy, NiTaB alloy, CoNiTa alloy, NiFe alloy, NiFeMo alloy, NiFeCr alloy, NiFeV alloy or NiCo alloy is preferably used.

The seed layer preferably has a micro-crystal structure consisting of fine crystal grains or face-centered cubic structure.

Crystal structure can be controlled by properly determining the kinds and proportions of components other than Ni.

For example, a micro-crystal structure can be easily obtained by using NiTa alloy, NiNb alloy, NiTaC alloy, NiTaB alloy or CoNiTa alloy. Face-centered cubic structure can be easily obtained by using NiFe alloy, NiFeMo alloy, NiFeCr alloy, NiFeV alloy or NiCo alloy.

When the seed layer is formed in a micro-crystal structure, grains in the under layer can be made uniform and finer. Especially when the non-magnetic matrix that forms the under layer is made of Y₂O₃ and the grains are made of a noble metal (such as Pt or Au) that has a close-packed structure, grains in the under layer tend to be made uniform and fine. When the seed layer is formed in face-centered cubic structure, the under layer can be formed with high crystallinity.

Thus in the magnetic recording medium having the seed layer as described above, crystallinity of the under layer can be improved over a case in which the under layer is formed directly on the soft magnetic layer.

The seed layer may also be formed from a soft magnetic material such that, for example, magnetic flux density for saturation Bs is 0.2 T or higher and coercive force Hc is 100 Oe or less.

When a soft magnetic material is used in the seed layer, the distance between the layer having soft magnetic characteristic (the seed layer and the soft magnetic layer) and the magnetic head becomes smaller, and therefore spacing loss is reduced and an effect to improve the recording resolution can be achieved.

The under layer has a grain isolation type structure, namely granular structure, where grains made of non-magnetic material are isolated in a non-magnetic matrix. This under layer may hereafter be referred to as the first under layer.

The non-magnetic matrix of the under layer is preferably formed from a non-magnetic material containing Y₂O₃. Grains are preferably made of a non-magnetic material containing at least one element selected from among Pt, Pd, Ru and Rh.

In the under layer of the constitution described above, the grains become uniform and fine and are clearly segregated from the matrix, with the orientation also being improved. Thus the magnetic recording layer formed on the under layer has good characteristics in terms of uniformity of grains, sharpness of grain boundary, fineness of the grains and orientation.

Especially when the non-magnetic matrix is made of a material containing Y₂O₃ and the grains are made of a material containing Pt, uniformity of grains, sharpness of grain boundary, fineness of the grains and orientation become even better.

Such a constitution may also be employed as the under layer is made of a material containing at least one kind selected from among metal oxide, metal nitride, metal carbide, oxide of semiconductor, nitride of semiconductor and carbide of semiconductor, and the grains are made of a non-magnetic material containing at least one element selected from among Au, Ag and Cu.

As the metal, Cr, Al, Ta, Zr, Mg or Y may be used. As the semiconductor, Si or B may be used.

The non-magnetic matrix is preferably made of a material containing at least one selected from among SiO₂, Y₂O₃, Cr₂O₃, Al₂O₃, and Ta₂O₅.

In the under layer of the constitution described above, since the grains are made of Au or the like are less likely to be influenced by the non-magnetic matrix, grains having good characteristics in terms of uniformity, sharpness of grain boundary and fineness can be obtained and orientation is also improved.

In the case in which the non-magnetic matrix is made of a material containing SiO₂ and the grains are made of a material containing Au, grain characteristics are improved further in terms of uniformity of grains, sharpness of grain boundary, fineness of the grains and orientation.

A second under layer made of a material containing Ru may be provided between the under layer and the magnetic recording layer. As this material, Ru or Ru alloy may be used. As the Ru alloy, RuCr alloy, RuCo alloy or RuPt alloy may be used.

Providing the second under layer improves the orientation of the magnetic recording layer and also improves the recording resolution and SNR (signal to noise ratio).

The magnetic recording layer may be made of Co alloy, and is preferably made of a Co alloy containing metal oxide or an oxide of semiconductor. The magnetic recording layer may be formed in a grain isolation type structure (granular structure).

The Co alloy may be CoCr alloy, CoPt alloy, CoCrPt alloy, CoCrPtTa alloy, CoCrPtO alloy or CoCrPtTaB alloy, As the metal, Cr, Al, Ta, Zr, Mg or Y may be used. As the semiconductor, Si or B may be used.

The metal oxide may be at least one kind selected from among Y₂O₃, Cr₂O₃, Al₂O₃, and Ta₂O₅. The oxide of semiconductor may be SiO₂ or B₂O₃.

When the magnetic recording layer is formed with a granular structure, the magnetic recording layer can have such a constitution as the magnetic grains made of the Co alloy described above are isolated in the matrix made of the metal oxide or the oxide of semiconductor described above.

Since the under layer has good characteristics in terms of uniformity of grains, sharpness of grain boundary, fineness of the grains and orientation, the magnetic recording layer that is formed by epitaxial growth under the influence of the under layer also has good characteristics in terms of uniformity of grains (magnetic grains), sharpness of grain boundary, fineness of the grains and orientation.

The magnetic recording layer made of a Co alloy containing metal oxide or oxide of semiconductor, in particular, has good characteristics in terms of uniformity of grains, sharpness of grain boundary, fineness of the grains and orientation. As a result, excellent resolution and noise characteristic can be obtained.

When a Co alloy containing metal oxide or oxide of semiconductor is used for the magnetic recording layer, it is preferable to form the magnetic recording layer under non-heating conditions (for example, with a substrate temperature lower than 100° C.). When the temperature is too high, grains grow too large, resulting in insufficient segregation of the grains from the matrix.

When a Co alloy that does not include metal oxide or oxide of semiconductor is used for the magnetic recording layer, it is preferable to form the magnetic recording layer under heating conditions (for example, with a substrate temperature of 100° C. or higher). When the temperature is too low, segregation in the magnetic recording layer tends to be insufficient.

When a Co alloy that does not include metal oxide or oxide of semiconductor is used for the magnetic recording layer, such a weak magnetic under layer may be provided directly below the magnetic recording layer that is made of a Co alloy having lower Co concentration than the Co alloy described above (for example, CoCr alloy, CoPt alloy, CoCrPt alloy, CoCrPtTa alloy, CoCrPtO alloy or CoCrPtTaB alloy). The weak magnetic under layer may also be a non-magnetic layer.

The weak magnetic under layer has saturation magnetization of preferably 300 emu/cm³ or less, more preferably from 10 to 100 emu/cm³, and coercive force of preferably from 0.5 to 100 Oe. When saturation magnetization or coercive force exceeds the range described above, medium noise tends to increase.

The magnetic recording layer can be a perpendicular magnetic recording layer where axis of easy magnetization is oriented mainly in the direction perpendicular to the substrate surface.

The magnetic recording layer may be provided with a protective layer made of C, SiO₂, ZrO₂ or the like formed thereon.

The protective layer may be provided with a lubrication layer made of perfluoropolyether, alcohol fluoride, carboxyl acid fluoride or the like formed thereon.

The layers described above may be formed either on one side of the substrate or on both sides thereof. The layers can be formed by the common sputtering process.

Now the present invention will be described in more detail by way of examples.

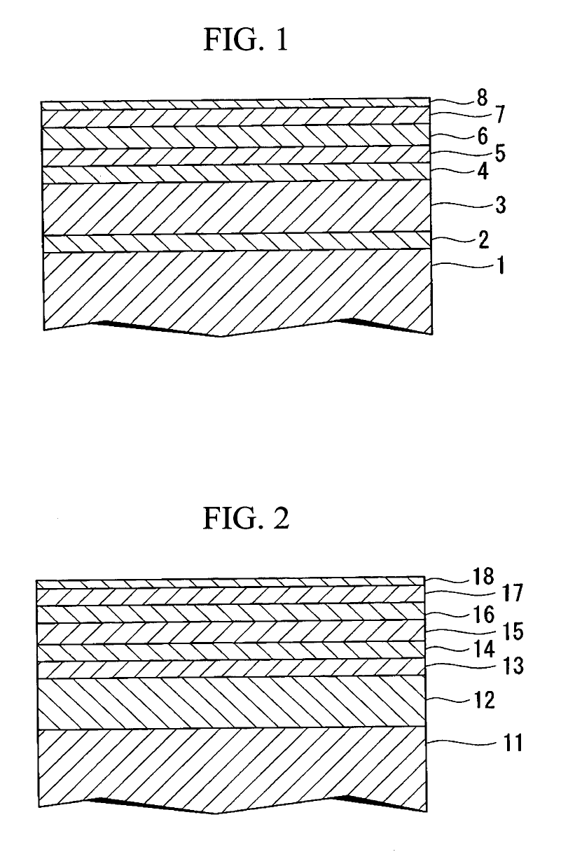

The magnetic recording medium shown in FIG. 1 has a structure in which the magnetic domain control layer 2, the soft magnetic layer 3, the seed layer 4, the first under layer 5, the second under layer 6, the magnetic recording layer 7 and the protective layer 8 are successively formed on the substrate 1.

The seed layer 4 may be made of NiTa alloy.

The first under layer 5 may be formed with a granular structure in which grains made of Pt are isolated in a matrix made of Y₂O₃. The second under layer 6 may be made of Ru.

The magnetic recording layer 7 may be formed with a granular structure in which magnetic grains made of CoCrPt alloy are isolated in a matrix made of SiO₂. The magnetic recording layer 7 is preferably formed under non-heating conditions (for example, with a substrate temperature lower than 100° C.). This is for the purpose of preventing the grains from growing too large due to the heat resulting in difficulty in segregating the grains from the matrix.

The magnetic recording medium shown in FIG. 2 has a structure in which a soft magnetic layer 12, a seed layer 13, a first under layer 14, a second under layer 15, a weak magnetic under layer 16, a magnetic recording layer 17 and a protective layer 18 are successively formed on a substrate 11.

The seed layer 13 may be made of NiTa alloy.

The first under layer 14 may be formed in a granular structure in which grains made of Au are isolated in a matrix made of SiO₂. The second under layer 15 may be made of RuCr alloy.

Both the weak magnetic under layer 16 and the magnetic recording layer 17 are made of CoCrPtB alloy, while the magnetic recording layer 17 contains Co in higher proportion than in the weak magnetic under layer 16.

The magnetic recording layer 17 is preferably formed under heating conditions by heating the substrate 11 (for example, with a substrate temperature of 100° C. or higher). This is because segregation of Cr in the magnetic recording layer 17 is accelerated by heating.

Since the magnetic recording medium of the present invention has the seed layer made of a material containing Ni and the first under layer having the grain isolation type structure, uniformity of grains, sharpness of grain boundary, fineness of the grains and crystal orientation in the first under layer can be improved.

As a result, uniformity of grains, sharpness of grain boundary, fineness of the grains and crystal orientation can be improved also in the second under layer and in the magnetic recording layer that are formed on the first under layer.

As a consequence, medium noise can be reduced and noise characteristics can be improved. It is also made possible to increase the coercive force and achieve satisfactory recording and reproduction characteristic. Thus, high density recording is made possible.

In the conventional device that has an under layer of granular structure made of Ru or the like and does not have a seed layer, in contrast, orientation in the under layer becomes poor and therefore noise characteristics and coercive force become insufficient.

According to the present invention, recording resolution can be improved by using the soft magnetic material in the seed layer.

The magnetic recording layer of the present invention shows particularly good characteristics when the magnetic recording layer has perpendicular magnetic anisotropy.

In this case, the magnetic recording medium becomes a so-called perpendicular double-layer medium that has a soft magnetic layer of high magnetic permeability and a perpendicular magnetic recording layer. In the perpendicular double-layer medium, the soft magnetic layer carries out a part of the function to deflect the recording magnetic field generated by the magnetic head (particularly by a single magnetic pole head) in the horizontal direction and direct it back toward the magnetic head. This causes a steep and sufficient perpendicular magnetic field to be applied to the magnetic recording layer so as to improve the efficiency of recording and reproduction.

A magnetic recording/reproducing apparatus of the present invention comprises the magnetic recording medium described above and a magnetic head. The magnetic head may be a recording head, a reproduction head, or a recording and reproduction composite head.

When perpendicular magnetic recording is employed, a single magnetic pole head may be used as the recording head. When longitudinal magnetic recording is employed, a ring head may be used as the recording head.

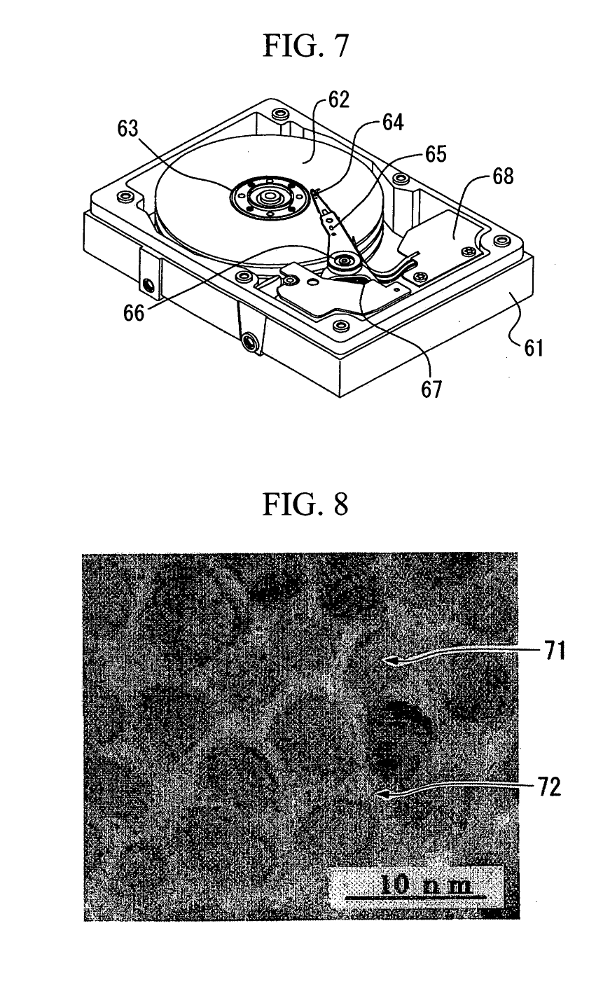

FIG. 7 is a partially exploded perspective view showing an example of the magnetic recording/reproducing apparatus of the present invention.

The magnetic recording/reproducing apparatus shown has a chassis 61 of rectangular box shape that is open at the top and a top cover that closes the opening of the chassis 61.

The chassis 61 contains a perpendicular magnetic recording medium 62 that is a magnetic recording medium having the constitution described above, a spindle motor 63 acting as the drive means that supports and rotates the perpendicular magnetic recording medium 62, a magnetic head 64 that records and reproduces magnetic signals to and from the perpendicular magnetic recording medium 62, a head actuator 65 that has a suspension bearing the magnetic head 64 mounted at the distal end thereof and supports the magnetic head 64 freely movably with respect to the perpendicular magnetic recording medium 62, a rotary shaft 66 that supports the head actuator 65 freely rotatably, a voice coil motor 67 that rotates and positions the head actuator 65 via the rotary shaft 66 and a head amplifier circuit 68.

### EXAMPLES

Now, examples of the magnetic recording medium of the present invention will be described below.

### Example 1

The magnetic recording medium shown in FIG. 1 was fabricated.

The manufacturing process described below was employed using a chamber that was evacuated to 3×10⁻⁵ Pa or lower for sputtering with Ar gas used as the sputtering gas.

The magnetic domain control layer 2 was formed on the non-magnetic glass substrate 1 by sputtering.

The magnetic domain control layer 2 was formed in such a structure as a second layer (20 nm thick) made of Co-18 at % Pt-8 at % Cr was formed on a first layer (40 nm thick) made of V. When forming the first layer, pressure in the chamber was set to 0.6 Pa and, when forming the second layer, pressure in the chamber was set to 0.5 Pa.

Then the soft magnetic layer 3 (200 nm thick) made of Co-6 at % Zr-10 at % Nb was formed on the magnetic domain control layer 2 (pressure in the chamber was 0.6 Pa).

Then the seed layer 4 (7 nm thick) made of Ni-30 at % Ta was formed on the soft magnetic layer 3 (pressure in the chamber was 0.7 Pa).

When forming the layers described above, DC electric power of 500 W was supplied to the target.

Then, the first under layer 5 (10 nm thick) made of Pt—Y₂O₃ was formed on the seed layer 4. The first under layer 5 was formed in a granular structure in which grains made of Pt were isolated in the matrix made of Y₂O₃. When forming the first under layer 5, a Pt—Y₂O₃ target made by sintering a mixture of Pt particles and Y₂O₃ particles in mole ratio of Pt:Y₂O₃=8:2 was used (pressure in the chamber was 5.0 Pa and RF power of 300 W was supplied).

Then the second under layer 6 (5 nm thick) made of Ru was formed on the first under layer 5 (pressure in the chamber 3.0 Pa and DC power supply 250 W).

Then the magnetic recording layer 7 (10 nm thick) made of CoPtCr—SiO₂ was formed on the second under layer 6. When forming the magnetic recording layer 7, a CoPtCr—SiO₂ target made by sintering a mixture of particles made of Co-16 at % Pt-12 at % Cr and SiO₂ particles in mole ratio of CoPtCr: SiO₂=11:1 was used (pressure in the chamber was 6.0 Pa and RF power of 200 W was supplied).

Then the protective layer 8 (7 nm thick) made of C was formed on the magnetic recording layer 7 (pressure in the chamber was 0.5 Pa and DC power of 1000 W was supplied).

Then a lubricating agent made of PFPE (perfluoro polyether) was applied onto the protective layer 8 by dipping process to form the lubricating layer (1.5 nm thick), thereby to obtain the magnetic recording medium A.

Magnetostatic characteristics of the magnetic recording medium A were measured using a Kerr effect magnetism measuring equipment with maximum magnetic field of 20 kOe. Coercive force Hc, squareness ratio RS and nucleation magnetic field Hn thus measured are shown in Table 1.

Table 1 also shows the values of Δθ50 determined by measuring the rocking curve using XRD in order to study the crystal orientation of the medium A.

The medium A was also subjected to R/W test by writing signals thereon using a single magnetic pole head and reading the signals with a GMR head. SNRm, overwriting characteristic (OW characteristic) and dPW50 thus determined are shown in Table 1. The measurement was made along a track 20 mm in radius of the medium A rotating at 4200 rpm.

As for the SNRm that shows the S/N ratio, S represents the peak value of isolated waveform of 119 kFCI in one cycle of magnetization reversal, that is, the difference of maximum value and minimum value divided by 2. Nm is the rms (root mean square-inches) with 716 kFCI.

The OW characteristic is represented by the ratio of signal output before overwriting to the remaining signal output after overwriting, when the signal was written with 358 kFCI after writing the recording signal with 8 kFCI. Half width dPW50 of magnetization reversal, that represents the resolution, is the width (nm) at 50% of the peak height of the isolated waveform obtained by differentiating the reproduction waveform.

Three samples were fabricated as follows.

Sample 1 was fabricated by forming the magnetic domain control layer 2, the soft magnetic layer 3 and the seed layer 4 on the non-magnetic glass substrate 1 in the same manner as in Example 1.

Sample 2 was fabricated by forming the magnetic domain control layer 2, the soft magnetic layer 3, the seed layer 4 and the first under layer 5 on the non-magnetic glass substrate 1 in the same manner as in Example 1.

Sample 3 was fabricated by forming only the seed layer 4 on the non-magnetic glass substrate 1 in the same manner as in Example 1.

In the XRD (X ray diffraction) pattern of Sample 1, no conspicuous peak was observed except for a weak peak, supposedly caused by the magnetic domain control layer, near 2θ=40 degrees, with a broad pattern observed near 2θ=40 to 50 degrees.

TEM (transmission electron microscope) observation of the planar structure of the seed layer 4 showed that the seed layer 4 had a micro-crystal structure consisting of fine grains measuring 2 nm or less.

Planar structure of the first under layer 5 of Sample 2 was observed with TEM.

FIG. 8 shows the planar structure (magnification 1,000,000 times). Reference numeral 71 in the photograph indicates a Pt grain and reference numeral 72 indicates the non-magnetic matrix made of Y₂O₃.

The photograph shows such a structure as the Pt grains 71 having mean grain size of about 6 nm are isolated in the non-magnetic matrix 72, in other words, the non-magnetic matrix 72 surrounds the Pt grains 71. Mean distance between Pt grains 71 is about 2 nm.

While the largest size of the Pt grain 71 is about 9 nm, sizes of most of the Pt grain 71 fall within a range of ±1 nm of the average.

Specimen measuring 1 cm square cut out of Sample 3 was measured with VSM (vibrating sample magnetometer) to determine the magnetostatic characteristics under 100 Oe of external magnetic field at the maximum. Soft magnetic characteristic was verified with the value of Bs being 0.2 T.

### Comparative Example 1

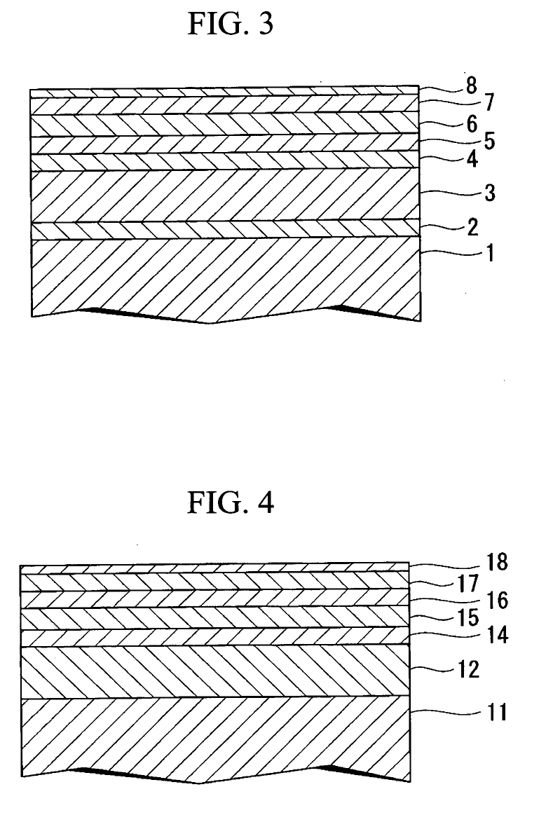

The magnetic recording medium B was fabricated in the same manner as in Example 1 except for using Ta as the material to form the seed layer 4, as shown in FIG. 3.

Magnetostatic characteristics, crystal orientation and R/W characteristic were measured in the same manner as in Example 1. The results are shown in Table 1.

Sample 4 was fabricated by forming the magnetic domain control layer 2, the soft magnetic layer 3, the seed layer 4 and the first under layer 5 on the non-magnetic glass substrate 1 in the same manner as in Comparative Example 1.

Planar structure of the first under layer 5 of Sample 4 was observed with TEM. The observation showed blurred boundaries of the grains and the matrix, indicating insufficient segregation of grains. While mean grain size was about 6 nm, the largest size of the grain was about 10 nm. Grain sizes scattered in a range of ±2 nm, indicating that the sample 4 was inferior to the medium A in terms of grain size uniformity.

TABLE 1

| | | Hc | RS | −Hn | [symbol] θ 50 | SNRm | OW | dPW50 |
|---|---|---|---|---|---|---|---|---|
| | Medium | (kOe) | (−) | (kOe) | (deg) | (dB) | (dB) | (nm) |
| Example 1 | A | 3.72 | 0.99 | 1.1 | 3.8 | 23.2 | 41.2 | 68 |
| Comparative | B | 3.68 | 0.89 | 0.8 | 5.4 | 20.8 | 40.9 | 75 |
| Example 1 | | | | | | | | |
| Example 3 | E | 3.69 | 0.96 | 1.0 | 4.5 | 22.8 | 40.9 | 74 |
| Example 4 | F | 3.58 | 0.92 | 0.8 | 5.2 | 22.0 | 41.1 | 73 |

From Table 1, it can be seen that there are no significant differences in coercive force Hc between Example 1 (medium A) and Comparative Example 1 (medium B), although medium A showed greater value of squareness ratio RS. The value of Δθ50 that shows crystal orientation is smaller in medium A, indicating better orientation.

Medium A and medium B showed comparable value of OW, but medium A showed better values of SNRm and dPW50.

From these results, it can be considered that, although the magnetic recording layer of medium B was made of fine grains, grain sizes were less scattered and better orientation was achieved in medium A. Supposedly medium A showed better characteristics partly because the seed layer 4 had soft magnetic characteristic, thus resulting in less spacing loss.

From the descriptions above, it can be seen that medium A has greater squareness ratio and better magnetostatic characteristics, with higher resolution and greater S/N ratio with regards to the R/W characteristics.

When the first under layer 5 was made by using Pd, Ru, or Rh instead of Pt used in medium A, RS value of about 0.9 and SNRm value 0.2 to 0.3 dB lower than that of medium A were obtained. This may be regarded as comparable performance to that of medium A.

When the seed layer 4 was made by using NiNb, NiTaC, NiTaB or CoNiTa instead of NiTa, the characteristics described above comparable to those of medium A were obtained.

When the seed layer 4 was made by using NiFe, NiFeMo, NiFeCr, NiFeV or NiCo instead of NiTa, it was found from the diffraction pattern of XRD that the seed layer 4 was formed in crystalline structure. Thus SNR was improved over medium B also in the case in which the seed layer 4 was formed in crystalline structure.

When the seed layer 4 was made by using NiFe, NiFeMo, NiFeCr or NiFeV instead of NiTa, Bs of about 0.8 T was achieved in every case. Thus, more conspicuous effect of reducing the spacing loss was achieved resulting in an improvement in dPW50.

### Example 2

A magnetic recording medium shown in FIG. 2 was fabricated.

A soft magnetic layer 12 (200 nm thick) made of Fe-10 at % Ta-10 at % C was formed on the non-magnetic glass substrate 11.

Then a seed layer 13 (8 nm thick) made of Ni-15 at % Ta-15 at % C was formed (pressure in the chamber was 0.8 Pa).

Then a first under layer 14 (5 nm thick) made of Au—SiO₂ was formed by using an Au target and an SiO₂ target that were disposed side by side in the same plane and repeating an operation of moving the substrate 11 from a position to oppose one of the two targets to a position to oppose the other so as to sputter Au and SiO₂ alternately (DC power supplied to the Au target was 500 W, RF power supplied to the SiO₂ target was 1400 W).

Then a substrate 11 was heated for 8 seconds to raise its temperature to 250° C.

Then a second under layer 15 (5 nm thick) made of Ru-30 at % Cr was formed on the first under layer 14 (pressure in the chamber was 3 Pa, DC power of 250 W was supplied).

Then a weak magnetic under layer 16 (10 nm thick) made of Co-26 at % Cr-12 at % Pt-4 at % B was formed (pressure in the chamber was 0.5 Pa, DC power of 100 W was supplied).

Then a magnetic recording layer 17 (12 nm thick) made of Co-18 at % Cr-15 at % Pt-1 at % B was formed (pressure in the chamber was 0.6 Pa, DC power of 250 W was supplied).

Then a protective layer 18 (7 nm thick) made of C was formed on the magnetic recording layer 17 (pressure in the chamber was 0.5 Pa, DC power of 1000 W was supplied).

Then a lubricating agent made of PFPE was applied onto the protective layer 18 by a dipping process to form a lubricating layer (1.3 nm thick), thereby to obtain the magnetic recording medium C.

Magnetostatic characteristics, crystal orientation and R/W characteristic of the magnetic recording medium C were measured in the same manner as in Example 1, with the results shown in Table 2.

Sample 5 was fabricated by forming only the seed layer 13 on the non-magnetic glass substrate 11 in the same manner as in Example 2.

Sample 6 was fabricated by forming the soft magnetic layer 12, the seed layer 13 and the first under layer 14 on the non-magnetic glass substrate 11 in the same manner as in Example 2.

Observation of XRD pattern of sample 5 showed a broad pattern observed near 2θ=40 to 50 degrees, but no sharp peak was observed. TEM observation of the planar structure of the seed layer 13 showed that the seed layer 13 had a micro-crystal structure consisting of fine grains measuring 2 nm or less.

For sample 6, observation of planar structure of the first under layer 14 using TEM at a magnification of 1,000,000 times showed granular structure where Au grains having mean grain size of about 7 nm are surrounded by the matrix made of SiO₂. Mean distance between Au grains was about 2 nm.

Specimen measuring 1 cm square cut out of Sample 5 was measured with VSM to determine the magnetostatic characteristic, and did not show magnetization as external magnetic field of up to 1500 kA/m was applied. Thus it was found that sample 5 was a non-magnetic material.

### Comparative Example 2

The magnetic recording medium D was fabricated in the same manner as in Example 2 except that the seed layer 13 was not formed as shown in FIG. 4.

Magnetostatic characteristics, crystal orientation and R/W characteristic of the medium D were measured in the same manner as in Example 1, with the results shown in Table 2.

TABLE 2

| | | Hc | RS | −Hn | [symbol] θ 50 | SNRm | OW | dPW50 |
|---|---|---|---|---|---|---|---|---|
| | Medium | (kOe) | (−) | (kOe) | (deg) | (dB) | (dB) | (nm) |
| Example 2 | C | 3.68 | 0.97 | 1.1 | 4.2 | 21.9 | 40.8 | 68 |
| Comparative | D | 3.71 | 0.85 | 0.8 | 5.7 | 19.7 | 38.2 | 72 |
| Example 2 | | | | | | | | |

From Table 2, it can be seen that Example 2 (medium C) was superior to Comparative Example 2 (medium D) in terms of magnetostatic characteristics, crystal orientation and R/W characteristics (SNRm). When the first under layer 14 was made by using Ag or Cu instead of Au used in medium C, performance that could be regarded as comparable to that of medium C was obtained in terms of the characteristics described above.

When the first under layer 14 was made by using Y₂O₃, Cr₂O₃, Al₂O₃, Ta₂O₅, MgO, TaC, TaN or ZrN instead of SiO₂, RS value was about 0.9 and SNRm was 0.1 to 0.3 dB lower than that of medium C. This may be regarded as comparable performance to that of medium C.

When the seed layer 13 was made by using NiNb, NiTaC, NiTaB or CoNiTa instead of NiTa, the characteristics described above were comparable to those of medium C.

When the seed layer 13 was made by using NiFe, NiFeMo, NiFeCr, NiFeV or NiCo instead of NiTa, it was found from the diffraction pattern of XRD that the seed layer 13 was formed in crystalline structure. Thus SNR was improved over medium D also in case the seed layer 13 was formed in crystalline structure.

When the seed layer 13 was made by using NiFe, NiFeMo, NiFeCr or NiFeV instead of NiTa, Bs of about 0.8 T was achieved in every case. Thus more conspicuous effect of reducing the spacing loss was achieved resulting in an improvement in dPW50.

### Example 3

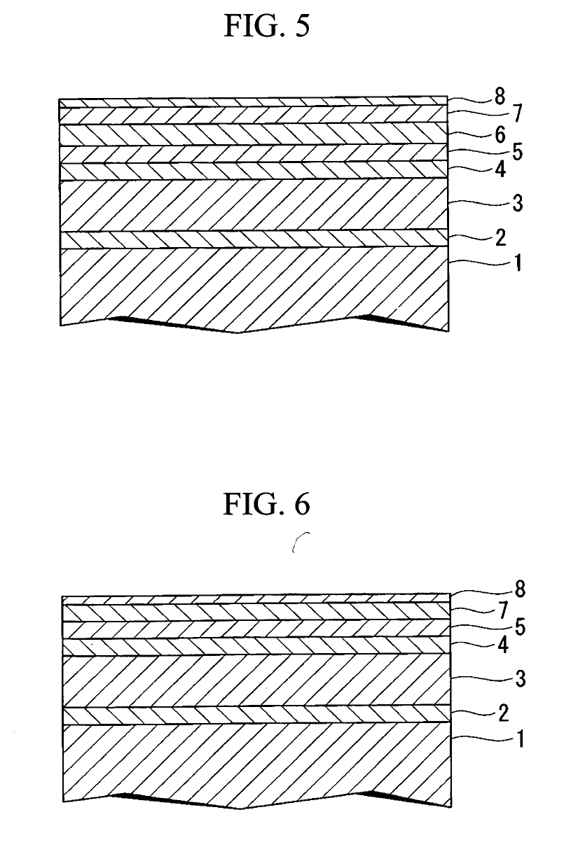

The magnetic recording medium E was fabricated in the same manner as in Example 1 except for using Rh instead of Pt in the first under layer 5, as shown in FIG. 5.

Magnetostatic characteristics, crystal orientation and R/W characteristic of the medium E were measured in the same manner as in Example 1, with the results shown in Table 1.

Sample 7 was fabricated by forming the magnetic domain control layer 2, the soft magnetic layer 3, the seed layer 4 and the first under layer 5 on the substrate 1 in the same manner as in Example 3.

Observation of planar structure of the first under layer 5 of the sample 7 with TEM showed granular structure where Rh grains having mean grain size of about 6 nm are surrounded by the matrix made of SiO₂. Largest grain size and smallest grain size being about 9 nm and about 3 nm, respectively, showed greater variations in the grain size than in the medium A.

As shown in Table 1, Example 3 (medium E) was superior to Comparative Example 1 (medium B) in terms of SNRm, but was inferior to Example 1 (medium A) in terms of dPW50.

Crystallinity of the medium E was improved by the use of Rh in the grains of the first under layer 5, but scatter of the grain sizes increased slightly and resolution decreased slightly.

The results of Example 1 and Example 3 show that use of Y₂O₃ in the matrix of the under layer makes the grains uniform and clear, so that a medium capable of recording with higher density can be obtained. In addition, use of Pt to make the grains in the under layer improves the orientation of the magnetic recording layer, thereby improving the resolution.

### Example 4

The magnetic recording medium F was fabricated in the same manner as in Example 1 except that the second under layer 6 was not formed, as shown in FIG. 6.

Magnetostatic characteristics, crystal orientation and R/W characteristic of the medium F were measured in the same manner as in Example 1, with the results shown in Table 1.

Sample 8 was fabricated by forming the magnetic domain control layer 2, the soft magnetic layer 3, the seed layer 4 and the first under layer 5 on the substrate 1 in the same manner as in Example 4.

Observation of planar structure of the first under layer 5 with TEM showed granular structure where Pt grains having mean grain size of about 6 nm are surrounded by the matrix made of Y₂O₃. Boundaries of these grains and the matrix were less clear than in the medium A.

As shown in Table 1, Example 4 (medium F) was superior to Comparative Example 1 (medium B) in terms of SNRm, but was inferior to Example 1 (medium A) in terms of Δθ50 and dPW50.

It is considered that, in the medium F, orientation of the magnetic recording layer 7 is somewhat inferior since the second under layer 6 is not formed, but better SNRM is obtained since Pt—Y₂O₃ is used in the first under layer 5.

Thus, it has been shown that the use of Pt—Y₂O₃ in the under layer makes it possible to obtain a medium capable of high density recording.

What is claimed is:

1. A magnetic recording medium comprising: a soft magnetic layer, a seed layer, an under layer and a magnetic recording layer stacked successively on a non-magnetic substrate, wherein
said seed layer is made of a material containing Ni; and
said under layer has a grain isolation type structure where grains made of a non-magnetic material are isolated in a non-magnetic matrix and the non-magnetic matrix is made of a material containing Y₂O₃.

2. The magnetic recording medium according to claim 1, wherein said grains are made of a non-magnetic material containing at least one element selected from among Pt, Pd, Ru and Rh.

3. A magnetic recording medium comprising: a soft magnetic layer, a seed layer, an under layer and a magnetic recording layer stacked successively on a non-magnetic substrate, wherein
said seed layer is made of a material containing Ni; and
said under layer has a grain isolation type structure where grains made of a non-magnetic material are isolated in a non-magnetic matrix and the non-magnetic matrix is made of a material containing at least one kind selected from among metal oxide, metal nitride, metal carbide, oxide of semiconductor, nitride of semiconductor and carbide of semiconductor, and said grains are made of a non-magnetic material containing at least one element selected from among Au, Ag and Cu.

4. The magnetic recording medium according to claim 3, wherein said non-magnetic matrix is a material containing at least one kind selected from among SiO₂, Y₂O₃, Cr₂O₃, Al₂O₃, and Ta₂O₅.

5. The magnetic recording medium according to claim 1, wherein a second under layer made of a material containing Ru is provided between said under layer and said magnetic recording layer.

6. The magnetic recording medium according to claim 3, wherein a second under layer made of a material containing Ru is provided between said under layer and said magnetic recording layer.

7. The magnetic recording medium according to claim 1, wherein said seed layer contains at least one element selected from among Fe, Co, Cr, V, Mo, Nb, Zr, W, Ta, B and C.

8. The magnetic recording medium according to claim 3, wherein said seed layer contains at least one element selected from among Fe, Co, Cr, V, Mo, Nb, Zr, W, Ta, B and C.

9. The magnetic recording medium according to claim 1, wherein said seed layer has magnetic flux density for saturation Bs of 0.2 T or higher and coercive force Hc of 100 (Oe) or less.

10. The magnetic recording medium according to claim 3, wherein said seed layer has magnetic flux density for saturation Bs of 0.2 T or higher and coercive force Hc of 100 (Oe) or less.

11. The magnetic recording medium according to claim 1, wherein said magnetic recording layer is made of a Co alloy containing a metal oxide or an oxide of a semiconductor.

12. The magnetic recording medium according to claim 3, wherein said magnetic recording layer is made of a Co alloy containing a metal oxide or an oxide of a semiconductor.

13. A method of manufacturing a magnetic recording medium comprising a soft magnetic layer, a seed layer, an under layer and a magnetic recording layer stacked successively on a non-magnetic substrate, wherein
said seed layer is made of a material containing Ni; and
said under layer has a grain isolation type structure where grains made of a non-magnetic material are isolated in a non-magnetic matrix and the non-magnetic matrix is made of a material containing Y₂O₃.

14. A method of manufacturing a magnetic recording medium, which comprises forming a soft magnetic layer, a seed layer, an under layer and a magnetic recording layer stacked successively on a non-magnetic substrate, wherein
said seed layer is made of a material containing Ni; and
said under layer has a grain isolation type structure where grains made of a non-magnetic material are isolated in a non-magnetic matrix and said non-magnetic matrix is made of a material containing at least one kind selected from among metal oxide, metal nitride, metal carbide, oxide of semiconductor, nitride of semiconductor and carbide of semiconductor, and said grains are made of a material containing at least one element selected from among Au, Ag and Cu.

15. A magnetic recording/reproducing apparatus comprising the magnetic recording medium of claim 1, and a magnetic head.

16. A magnetic recording/reproducing apparatus comprising the magnetic recording medium of claim 3, and a magnetic head.
